(19) United States
(12) Patent Application Publication
(10) Pub. No.: US 2023/0020141 A1
(43) Pub. Date: Jan. 19, 2023

(54) CLEANING APPARATUS

(71) Applicant: HAMMELMANN GMBH, Oelde (DE)

(72) Inventors: Martin OBERSCHEIDT, Ennigerloh (DE); Fabian STOFFERS, Rheda-Wiedenbrück (DE)

(21) Appl. No.: 17/783,777

(22) PCT Filed: Dec. 1, 2020
(86) PCT No.: PCT/EP2020/084097

§ 371 Date: Jun. 9, 2022

(30) Foreign Application Priority Data
Dec. 11, 2019 (DE) 10 2019 134 040.3

(51) Int. Cl. B05B 3/02; F16C 33/74; F16C 32/06

(52) U.S. Cl. CPC B05B 3/025; F16C 33/741; F16C 32/06; F16C 2235/00

(57) ABSTRACT

A cleaning apparatus has a hollow input shaft connectable to a hydraulic pressure source, is received in a first housing part and has a fluid conduit, with at least one lateral or axial input and at least one lateral output. At least one hollow output shaft is fluidically coupled to the hollow input shaft, received in a second housing part, and has a fluid channel, with at least one lateral input and at least one lateral or axial output. The hollow input shaft and/or the hollow output shaft is/are mounted rotatably about the longitudinal axis thereof relative to the relevant housing part. A first chamber is at least between the input or output of the hollow input shaft or the input of the at least one hollow output shaft and an interior lateral surface of a sealing sleeve. The sealing sleeve is fixed in a stationary and non-rotatable manner on the relevant housing part and arranged surrounding a portion of the hollow input or output shaft. Regions of the interior lateral surface of the sealing sleeve extending axially from the first chamber form a gap seal with the exterior lateral surface of the hollow input or output shaft.

### BACKGROUND AND SUMMARY OF THE INVENTION

Exemplary embodiments of the present invention relate to a cleaning apparatus having a hollow input shaft fluidically coupled to a hollow output shaft.

Such cleaning apparatuses known from the prior art, which are operated under high fluid pressures of up to 1800 bar, typically have a hollow input shaft and one or more hollow output shafts fluidically connected to the hollow input shaft. A pressure chamber provided between the output of the hollow input shaft and the input of the hollow output shaft, which is filled in operation with the liquid under high pressure, is sealed inside a housing via seal elements molded from a soft plastic or rubber.

These seal elements are arranged here so that the liquid under high pressure presses both against the seal elements themselves and also against an axial end face of the input shaft. The axial force thus exerted on the input shaft is absorbed by axial bearings between the input shaft and the housing surrounding it.

The force acting on the seal elements results in them being pressed into a gap provided between output shaft and housing, wherein the gap enables the rotational movement of the output shaft relative to the housing. The pressing of parts of the seal elements into this gap results, on the one hand, in undesired friction between output shaft and housing. On the other hand, this accelerates the wear of the seal elements.

Exemplary embodiment of the present invention are directed to a cleaning apparatus using which the above-mentioned disadvantages can be remedied, and in particular axial forces on the input shaft caused by the hydraulic pressure can be significantly reduced or avoided entirely.

The cleaning apparatus according to the invention has a hollow input shaft, which is connectable to a hydraulic pressure source, is accommodated in a first housing part, and has a fluid channel, having at least one lateral or axial input and at least one lateral output.

The cleaning apparatus furthermore has at least one hollow output shaft, which is fluidically coupled to the hollow input shaft, is accommodated in a second housing part, and has a fluid channel, and has at least one lateral input and at least one lateral or axial output.

The hollow input shaft and/or the hollow output shaft are rotatably mounted relative to the respective housing part around their longitudinal axis.

A first chamber is provided at least between the input or output of the hollow input shaft or the input of the at least one hollow output shaft and an inner jacket of a sealing sleeve.

The sealing sleeve is secured in a positionally and rotationally fixed manner on the respective housing part and encloses a part of the hollow input shaft or hollow output shaft.

Regions of the inner jacket of the sealing sleeve extending axially from the first chamber form a gap seal with the outer jacket of the hollow input shaft or the hollow output shaft.

The design of these transitions via sealing sleeves having first chamber provided in the inner jacket region prevents the liquid under high pressure from reaching into regions of the housing, in particular surfaces of the input or output shaft aligned perpendicularly to the longitudinal axis of the input or output shaft, so that because of this no axial forces form upon escape of the fluid under high pressure on the hollow input shaft or hollow output shaft. End faces transverse to the longitudinal extension of the hollow input shaft or hollow output shaft are thus no longer subjected to pressurized fluid, so that axial mounting of the hollow input shaft or hollow output shaft is thus no longer necessary or at least can be designed to be significantly smaller.

A further advantage of the arrangement of the sealing sleeves is that possible sealing elements cannot be pressed into the gap forming the gap seal between housing and hollow input shaft or hollow output shaft even under the high pressure load, because of which premature wear of the seal and friction caused by the seal are avoided by the use of such a sealing sleeve.

According to one advantageous embodiment variant of the invention, a second chamber is provided between an outer jacket of the sealing sleeve and an inner surface of the housing part, which is connected via a connecting channel to the first chamber and extends axially in relation to the hollow input shaft or hollow output shaft on both sides from the connecting channel.

Due to the second chamber provided in the jacket outer region, these regions of the sealing sleeve are under the same hydraulic pressure as the inner region of the fluid channel of the hollow input shaft or hollow output shaft, so that widening of the seal gap of the gap seal is prevented because of this.

According to a further advantageous embodiment variant, the first chamber is formed as a material recess on the inner jacket of the sealing sleeve and/or as a material recess on the respective adjacent jacket surface of the hollow input shaft or the hollow output shaft.

The second chamber is preferably also formed as a material recess on the outer jacket of the sealing sleeve and/or as a material recess on the respective adjacent jacket surface of the wall of the housing part.

According to an alternative advantageous embodiment variant, the second chamber is formed as a gap delimited by seal rings, wherein the seal rings are provided in ring grooves in the outer jacket surface of the sealing sleeve.

According to a further preferred embodiment variant of the cleaning apparatus according to the invention, the hollow input shaft is coupled to the at least one hollow output shaft via a mechanical gearing.

Separate drives for the hollow input shaft and the at least one hollow output shaft are thus not required.

The gap seal preferably forms a fluidic bearing.

According to a further preferred embodiment variant, the first housing part is mechanically coupled to the second housing part.

According to one preferred embodiment variant, the hollow output shaft is rotatable around an axis of rotation perpendicular to the axis of rotation of the hollow input shaft, which, in particular in consideration together with a further preferred embodiment variant, in which the output of the hollow output shaft is coupled in a nozzle holder to nozzles extending laterally to the longitudinal axis of the hollow output shaft, enables an extremely variable arrangement of the cleaning nozzles.

According to an alternative embodiment variant, the at least one hollow output shaft is rotatable around an axis of rotation parallel to the axis of rotation of the hollow input shaft.

Such a variant in particular enables a wide-area cleaning of a surface perpendicular to the axis of rotation of the hollow input shaft and hollow output shaft.

The hollow input shaft is coupled according to one preferred refinement via a gearing with at least two hollow output shafts arranged in parallel to one another.

According to still a further preferred refinement of a cleaning apparatus according to the invention, the second chamber of the sealing sleeve partially enclosing the hollow output shaft is fluidically coupled to a nozzle fixed in the second housing part.

The sealing sleeve is preferably manufactured from a bearing metal, preferably from bronze.

### BRIEF DESCRIPTION OF THE DRAWING FIGURES

Preferred embodiment variants of the invention are explained in more detail hereinafter on the basis of the appended drawings. In the figures:

FIGS. 1 and 2 show perspective views of a first embodiment variant of a cleaning apparatus according to the invention,

FIG. 3 shows a sectional view of the cleaning apparatus shown in FIGS. 1 and 2,

FIG. 4 shows a perspective illustration of an alternative embodiment variant of a cleaning apparatus according to the invention, and

FIG. 5 shows a sectional illustration through the cleaning apparatus according to FIG. 4.

### DETAILED DESCRIPTION

In the following description of the figures, terms such as upper, lower, left, right, front, rear, etc. relate exclusively to the illustration and position of the cleaning apparatus selected by way of example in the respective figures, hollow input shaft, hollow output shaft, input, output, sealing sleeve, and the like. These terms are not to be understood as restrictive, i.e., these references can change due to various working positions or the mirror-symmetrical design or the like.

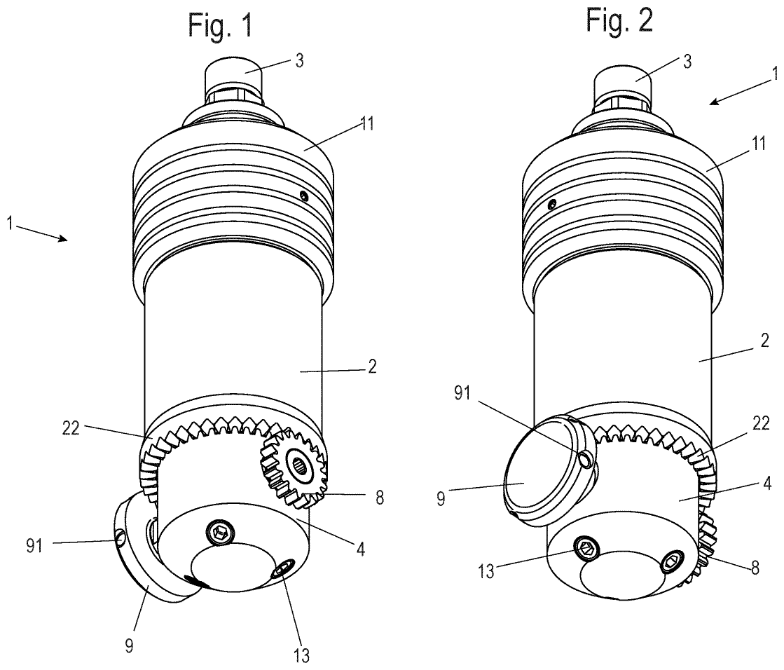

A first embodiment variant of a cleaning apparatus according to the invention is shown in FIGS. 1 to 3. The cleaning apparatus is identified as a whole here by the reference sign 1. Such a cleaning apparatus 1 is used, for example, to clean the interiors of tank containers.

The cleaning apparatus 1 has, as shown in FIGS. 1 to 3, a hollow input shaft 3 connectable to a hydraulic pressure source, which is accommodated in a first housing part 2 and has a central fluid channel 31 for conducting through a liquid under high pressure of up to approximately 1800 bar.

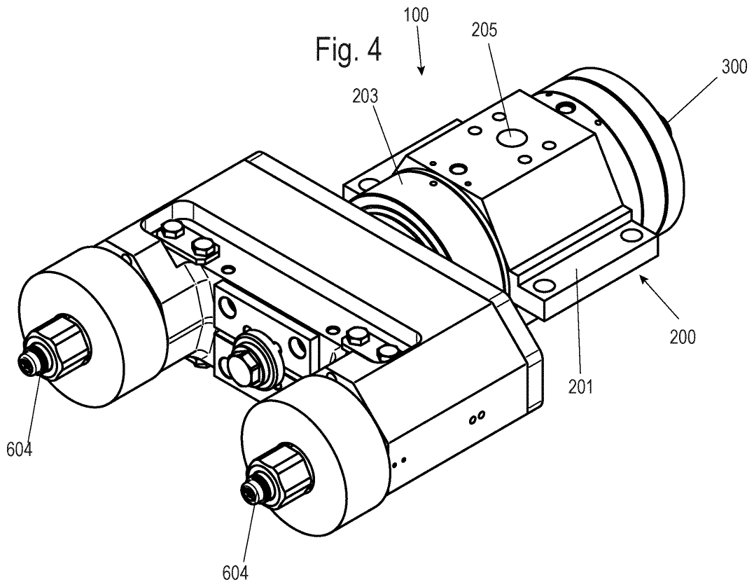

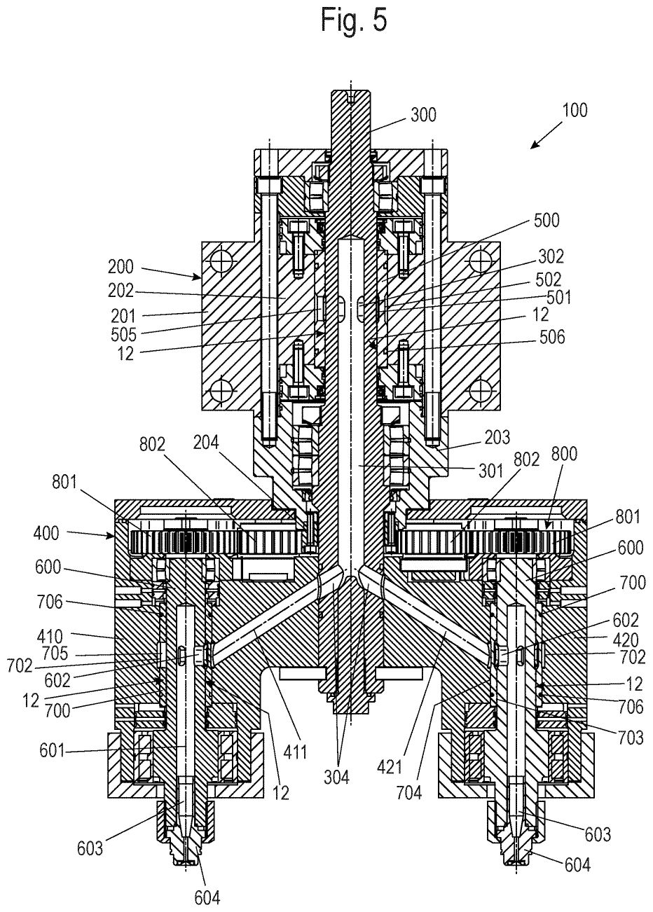

The liquid, for example, a water/detergent mixture, enters the fluid channel 31 here through an axial input 32 in the embodiment variant shown here. It is also conceivable to provide a laterally arranged input, which is oriented at an angle to the longitudinal axis of the hollow input shaft 3, as is the case, for example, on the basis of a second exemplary embodiment of a cleaning apparatus 100 according to the invention shown in FIGS. 4 to 5.

The hollow input shaft 3 furthermore has multiple lateral outputs 33. The lateral outputs 33 extend outward in the embodiment variant shown here radially away from the fluid channel 31 through the wall of the hollow input shaft 3 and open into a first chamber 51 of a sealing sleeve 5, which encloses the region of the hollow input shaft 3 having the outputs 33.

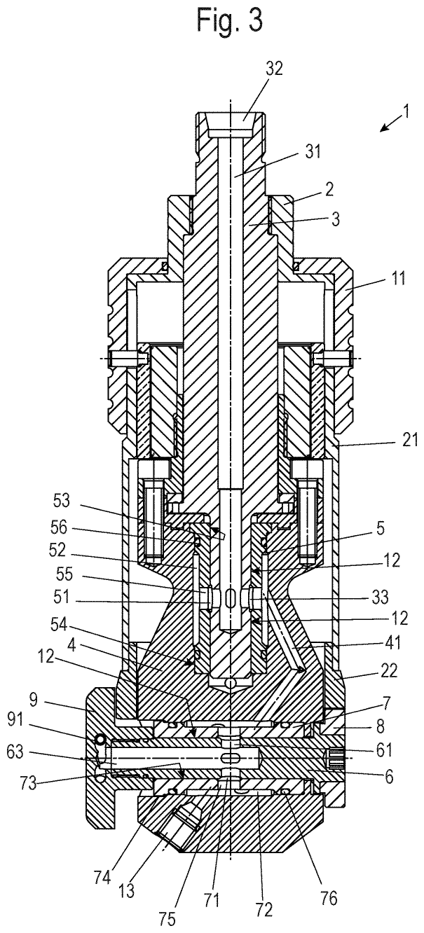

The sealing sleeve 5, as can furthermore be seen in FIG. 3, is accommodated in a second housing part 4, the inner wall of which delimits a second chamber 52 together with an outer jacket 54 of the sealing sleeve 5.

An inner jacket 53 of the sealing sleeve 5 forms a gap seal 12 with the hollow input shaft 3 to enable a rotational movement of the sealing sleeve 5 relative to the hollow input shaft 3.

In the embodiment variant shown here, the housing part 4 is rotatably mounted around the longitudinal center axis of the hollow input shaft 3.

The first chamber 51 of the sealing sleeve 5 is formed as a ring-shaped material recess in the inner jacket 53 of the sealing sleeve 5 and corresponds in its axial width approximately to the diameter of a channel 55 extending radially through the jacket of the sealing sleeve 5, which opens into the second chamber 52.

The second chamber 52 is formed into an outer jacket 54 of the sealing sleeve 5 and is preferably formed as a ring-shaped material recess in the outer jacket 54 of the sealing sleeve 5, which forms a closed ring space together with the wall of the housing part 4 enclosing it.

It is also conceivable, instead of the material recesses provided to form the first and/or second chamber 51, 52, to provide them not or not exclusively on the inner jacket 53 and/or outer jacket 54 of the sealing sleeve 5, but (also) on the respective adjacent jacket surface of the hollow input shaft 3 or the wall of the housing part 4.

It is additionally conceivable not to provide material recess(es) as described above for the second chamber 52, but rather to form the second chamber 52 as a gap delimited by seal rings 56, wherein the seal rings 56 are provided in ring grooves in the outer jacket surface 54 of the sealing sleeve 5, as shown by way of example in FIG. 3.

The width of this ring space viewed axially in relation to the hollow input shaft 3 is preferably greater in this embodiment variant than the width of the first chamber 51, also formed as a ring space, on the inner jacket of the sealing sleeve 5.

The channel 55 or several of the channels 55 open into the second chamber 52 axially viewed in relation to the hollow input shaft 3.

In operation, the liquid under high pressure fills the chambers 51, 52 and thus generates a pressure equilibrium between the inner jacket 53 and the outer jacket 54 of the sealing sleeve 5 in the regions of the second chamber 52.

The fluid pressure acts here on the surface of the sealing sleeve 5 forming the inner jacket 53 of the sealing sleeve 5 and thus on the gap seal 12, along which the pressure is dissipated.

Viewed axially in relation to the hollow input shaft 3, ring grooves are provided outside the second chamber 52 in the outer jacket surface 54 of the sealing sleeve 5, which are used to accommodate seal rings 56 to seal off the sealing sleeve 5 in relation to the inner wall of the second housing part 4.

Furthermore, a connecting channel 41 for conducting through the fluid under high pressure in the direction of a hollow output shaft 6 is introduced into the second housing part 4.

This connecting channel 41 opens here, on the one hand, into the second chamber 52 of the sealing sleeve 5 fluidically coupled to the first chamber 51 and at its other end into a further second chamber 72, which is fluidically connected to a further first chamber 71 of a further sealing sleeve 7.

The sealing sleeve 7, which corresponds in its structure and function to the sealing sleeve 5, encloses a partial region of the hollow output shaft 6, which is arranged in the second housing part 4 rotatably relative to the sealing sleeve 7.

The hollow output shaft 6 is accommodated here in the second housing part 4 rotatably around an axis of rotation perpendicular to the axis of rotation of the hollow input shaft 3.

The hollow input shaft 3 is coupled to the hollow output shaft 6 via a mechanical gearing.

For this purpose, in the first embodiment variant of the cleaning apparatus 1 shown in FIGS. 1 to 3, a gearing element 22, for example, a crown wheel or a friction wheel, is secured on an end face of a housing wall 21 of the housing part 2 remote from the input 32, which gearing element 22 has an operational connection to a corresponding second gearing element 8, for example, a gear wheel fastened on the hollow output shaft 6.

A nozzle holder 9 is placed on the hollow output shaft 6 on the end of the hollow output shaft 6 opposite to the second gearing element 8.

The nozzle holder 9 has at least one, in the exemplary embodiment shown multiple nozzles 91, which extend outward from the nozzle holder 9 laterally in relation to the longitudinal axis of the hollow output shaft 6.

As can furthermore be seen in FIGS. 1 to 3, it is also conceivable to arrange further nozzles 13 in an end face of the second housing part 4 inclined at an angle, which are fluidically coupled via a connecting channel to the second chamber 72 of the sealing sleeve 7 partially enclosing the hollow output shaft 6.

In the alternative embodiment variant of a cleaning apparatus 100 according to the invention shown in FIGS. 4 and 5, in contrast to the cleaning apparatus 1, two such hollow output shafts 600 are attached and fluidically connected to one hollow input shaft 300.

The hollow input shaft 300 has a lateral input 302 here, which is connected to a pressure fitting 205 provided in the first housing part 200. The hollow input shaft 300 is rotatably mounted relative to the housing part 200 around its longitudinal axis.

In the region of the input 302, the hollow input shaft 300 is enclosed by a sealing sleeve 500, which, corresponding to the first exemplary embodiment described above, has a first chamber 501, which is fluidically coupled to the input 302 of the hollow input shaft 300.

The first chamber 501 is also connected outward via a connecting channel 505 to a second chamber 502, which extends axially in relation to the hollow input shaft 300.

In the region of a second end of the channel 301 of the hollow input shaft 300, the channel 301 divides into two laterally extending channels 304, which open into respective connecting channels 411, 421 of a first wing 410 and a second wing 420 of a second housing part 400.

Respective sealing sleeves 700 are arranged at the end of these connecting channels 411, 421 in the second housing part 400, which enclose input regions of a respective hollow output shaft 600.

The sealing sleeves 500, 700 also correspond in principle in their construction and function to the sealing sleeve 5 described on the basis of the first exemplary embodiment.

The hollow output shafts 600 are rotatably mounted in parallel to the axis of rotation of the hollow input shaft 300 in this embodiment variant. For this purpose, the hollow input shaft 300 is coupled via two gearings 800 to the two hollow output shafts 600 arranged in parallel to one another.

Each of the gearings 800 in the exemplary embodiment shown here has a first gear wheel 801, which encloses the hollow output shaft 600, and a second gear wheel 802, which meshes with a gear wheel 204 fastened on the hollow input shaft 300.

The outputs 603 of the hollow output shafts 600 are aligned axially to the longitudinal channel 601 of the hollow output shaft 600 here. Respective nozzles 604 are connected to the outputs 603.

The gap seals 12 form a fluidic bearing. Moreover, axially acting internal fluid pressure forces are significantly reduced, in particular completely prevented, in operation of the cleaning apparatuses 1, 100.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

List of reference numerals

| | |
|---|---|
| 1 | cleaning apparatus |
| 2 | first housing part |
| 21 | housing wall |
| 22 | gearing element |
| 3 | hollow input shaft |
| 31 | channel |
| 32 | input |
| 33 | output |
| 4 | second housing part |
| 41 | connecting channel |
| 5 | sealing sleeve |
| 51 | first chamber |
| 52 | second chamber |
| 53 | inner jacket |
| 54 | outer jacket |
| 55 | connecting channel |
| 56 | seal ring |
| 6 | hollow output shaft |
| 61 | channel |
| 62 | input |
| 63 | output |
| 7 | sealing sleeve |
| 71 | first chamber |
| 72 | second chamber |
| 73 | inner jacket |
| 74 | outer jacket |
| 75 | connecting channel |
| 76 | seal ring |
| 8 | gearing element |
| 9 | nozzle holder |
| 91 | nozzle |
| 11 | outer jacket |
| 12 | gap seal |
| 100 | cleaning apparatus |
| 200 | first housing part |
| 201 | fastening flange |
| 202 | first housing part |
| 203 | second housing part |
| 204 | gear wheel |
| 205 | pressure fitting |
| 300 | hollow input shaft |
| 301 | channel |
| 302 | input |
| 303 | output |
| 304 | channel |
| 400 | second housing part |
| 410 | first wing |
| 411 | connecting channel |
| 420 | second wing |
| 421 | connecting channel |
| 500 | sealing sleeve |
| 501 | first chamber |
| 502 | second chamber |
| 503 | inner jacket |
| 504 | outer jacket |
| 506 | seal ring |
| 600 | hollow output shaft |
| 601 | channel |
| 602 | input |
| 603 | output |
| 604 | nozzle |
| 700 | sealing sleeve |
| 701 | first chamber |
| 702 | second chamber |
| 703 | inner jacket |
| 704 | outer jacket |
| 706 | seal ring |
| 800 | gearing |
| 801 | first gear wheel |
| 802 | second gear wheel |

1-13. (canceled)

14. A cleaning apparatus, comprising:
a hollow input shaft, which is connectable to a hydraulic pressure source, is accommodated in a first housing part, and has a fluid channel, wherein the fluid channel of the hollow input shaft has at least one lateral or axial input and at least one lateral output;
at least one hollow output shaft, which is fluidically coupled to the hollow input shaft, is accommodated in a second housing part, and has a fluid channel, wherein the fluid channel of the at least one hollow output shaft has at least one lateral input and at least one lateral or axial output, wherein the hollow input shaft or the hollow output shaft is rotatably mounted around its longitudinal axis relative to the first or second housing part, respectively;
a first chamber is arranged at least between an inner jacket of a sealing sleeve and the input of the hollow input shaft, the output of the hollow input shaft, or the input of the at least one hollow output shaft,
wherein the sealing sleeve is secured in a positionally and rotationally fixed manner on the first or second housing part and encloses a part of the hollow input shaft or hollow output shaft, and
wherein regions of the inner jacket of the sealing sleeve extending axially from the first chamber form a gap seal with an outer jacket of the hollow input shaft or with an outer jacket of the hollow output shaft.

15. The cleaning apparatus of claim 14, wherein a second chamber is arranged between an outer jacket of the sealing sleeve and an inner surface of the first or second housing part, wherein the second chamber is connected via a connecting channel to the first chamber and extends axially in relation to the hollow input shaft or hollow output shaft on both sides from the connecting channel.

16. The cleaning apparatus of claim 14, wherein the first chamber is a material recess on the inner jacket of the sealing sleeve or is a material recess on an adjacent jacket surface of the outer jacket of hollow input shaft or of the outer jacket of the hollow output shaft.

17. The cleaning apparatus of claim 15, wherein the second chamber is a material recess on the outer jacket of the sealing sleeve or is a material recess on an adjacent jacket surface of a wall of the first or second housing part.

18. The cleaning apparatus of claim 15, wherein the second chamber is a gap delimited by seal rings, wherein the seal rings are provided in ring grooves in a surface of the outer jacket of the sealing sleeve.

19. The cleaning apparatus of claim 18, wherein an internal diameter of the sealing sleeve in a region of the gap seal is equal on both sides of the connecting channel.

20. The cleaning apparatus of claim 14, wherein the hollow input shaft is coupled to the at least one hollow output shaft via a mechanical gearing.

21. The cleaning apparatus of claim 14, wherein the gap seal forms a fluidic bearing.

22. The cleaning apparatus of claim 14, wherein the at least one hollow output shaft is rotatable around an axis of rotation perpendicular to an axis of rotation of the first housing part.

23. The cleaning apparatus of claim 14, wherein the at least one hollow output shaft is rotatable around an axis of rotation parallel to an axis of rotation of the first housing part.

24. The cleaning apparatus of claim 14, wherein the at least one lateral or axial output of the hollow output shaft is coupled in a nozzle holder with nozzles extending laterally in relation to the longitudinal axis of the hollow output shaft.

25. The cleaning apparatus of claim 15, wherein the second chamber partially encloses the at least one hollow output shaft and is fluidically coupled to a nozzle secured in the second housing part.

26. The cleaning apparatus of claim 14, wherein the sealing sleeve is a bearing metal.
